(19) United States
(12) Patent Application Publication
(10) Pub. No.: US 2014/0210399 A1
(43) Pub. Date: Jul. 31, 2014

(54) PORTABLE ELECTRIC POWER SOURCE FOR AIRCRAFT

(71) Applicant: PYLON AVIATION SERVICES LLC, Chandler, AZ (US)

(72) Inventors: Scott Urschel, Chandler, AZ (US); Todd Alan Petersen, Scottsdale, AZ (US)

(73) Assignee: PYLON AVIATION SERVICES LLC, Chandler, AZ (US)

(21) Appl. No.: 13/750,295

(22) Filed: Jan. 25, 2013

(51) Int. Cl. H02J 1/00; H02J 7/00

(52) U.S. Cl. CPC H02J 1/00; H02J 7/007; H02J 7/0063
USPC 320/107; 307/150; 320/137; 320/136

(57) ABSTRACT

A method and apparatus for providing portable ground power for aircraft. A ground power unit includes a lithium ion cell battery assembly and a standard three-pin aircraft ground power connector integrated into a single unit and packaged inside a ruggedized plastic housing with a carry handle, thereby eliminating the heavy and bulky power cables between the battery and connector. A battery management unit sets charge/discharge limits and provides monitoring of state of charge, health, and function. A charging connector and charging circuitry with user-selectable regulated charging limits allows simultaneous charging and discharging operations and connection into aircraft auxiliary circuits. A ganging station is provided to electrically combine the outputs of several ground power units in parallel for starting larger aircraft.

### BACKGROUND OF THE INVENTION

1. Field of the Invention

This invention relates generally to aircraft and aircraft services, portable power supplies, and in particular to ground support equipment and emergency apparatus used for starting aircraft.

2. Background Art

A ground power unit (“GPU”), such as that illustrated in FIG. 1, is commonly used for starting aircraft. A standard ground power unit (10) includes a battery power source (12), a multistage electronic charger (14), and large gauge heavy duty power cables (16) typically terminated with a NATO aviation connector (18), which plugs into a complementary connector on the aircraft. Most GPUs are heavy and are therefore carried on wheels (20) so that they can be rolled for easier transportation about the airfield.

To start an aircraft, a ground crew wheels the GPU (10) to a location near the aircraft, removes the electrical cables (16) from stowage, and connects them to the input connector of the aircraft. After start-up, the cables (16) are unplugged and stowed, and the GPU unit is wheeled away for storage.

A concern for a pilot, particularly with helicopters, is starting the engine when the aircraft has landed in a remote location. The pilot will have to rely on the aircraft primary battery to restart the engine. If the primary battery does not have enough charge or power to start the engine, the aircraft will be stranded and will require fly-in help.

“Portable” ground power battery packs are commercially available, which can be carried aboard aircraft for remote starting situations. One such power pack is shown in FIG. 2. Power pack (30) includes a battery (32) and charger (34) in a tool-tray-style housing (36) with a carry handle (38). The top of the housing includes an open bin (40) for storage of the large gauge power cables (42) and NATO connector. Power pack (30) may use lead-acid or lithium ion batteries, with the latter weighing less. However, the commercially available portable ground power battery packs are still quite bulky and heavy, typically weighing over 30 pounds, with the large-conductor power cables contributing significantly to the overall size and weight.

Accordingly, a truly portable power pack for remote starting of aircraft that has minimal size and weight penalty on aircraft operations is desirable.

3. Identification of Objects of the Invention

A primary object of the invention is to provide a method and apparatus for providing portable battery-supplied ground power to an aircraft that is small and light, so as to allow for carrying aboard aircraft with minimum weight and balance penalty.

Another object of the invention is to provide a method and apparatus for providing continuous ground power to an aircraft while simultaneously being charged by an independent source of power.

Another object of the invention is to provide a method and apparatus for semi-permanently installing a portable battery-supplied ground power unit within an aircraft using an aircraft auxiliary circuit for charging if its battery.

Another object of the invention is to provide a method and apparatus for providing portable battery-supplied ground power to an aircraft that has user-selectable regulated charging current levels.

Another object of the invention is to provide a method and apparatus for combining the output of several portable battery ground power units to allow for starting larger aircraft.

### SUMMARY OF THE INVENTION

The objects described above and other advantages and features of the invention are incorporated in a method and a portable ground power unit for staring aircraft. In one or more preferred embodiments, the ground power unit includes a lithium ion cell battery assembly and a standard three-pin aircraft ground power connector integrated into a single unit and packaged inside a ruggedized plastic housing with a carry handle, thereby eliminating the heavy and bulky power cables inherent in other ground power systems.

The portable ground power unit includes a battery management unit, which sets charge/discharge limits and ensures the overall safety of the system. Battery protection circuitry, which provides firmware monitoring of voltage and current levels and state of battery charge and health, is enabled to disconnect the battery assembly from an external load or a charger to prevent battery failure or dangerous operating conditions.

A charging connector, apart from the aircraft ground power connector, allows simultaneous charging and discharging operations. An intelligent charging circuit allows user-selectable regulated charging current limits, which allows the ground power unit to be semi-permanently installed aboard an aircraft and charged via a low-current aircraft auxiliary power circuit.

A ganging station is provided which receives a number of portable ground power units via their standard three-pin aircraft ground power connectors. The ganging station is operable to electrically combine the outputs of the ground power units in parallel for starting larger aircraft.

### BRIEF DESCRIPTION OF THE DRAWINGS

The invention is described in detail hereinafter on the basis of the embodiments represented in the accompanying figures, in which:

FIG. 1 is a perspective view of a typical ground power unit of prior art, showing a wheeled metal housing carrying batteries, an electronic charger unit, and heavy gauge power cables;

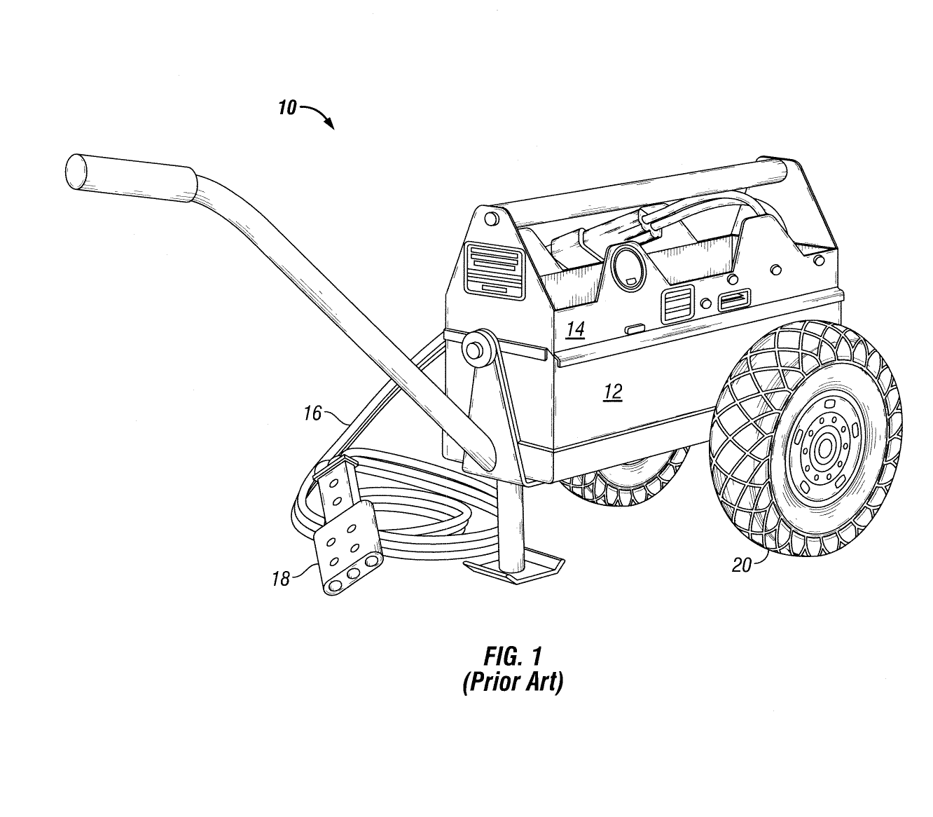

FIG. 2 is a perspective view of a portable ground power battery pack of prior art, showing a tool-tray-style metal housing carrying lithium ion batteries or the like, an electronic charger unit, and heavy gauge power cables;

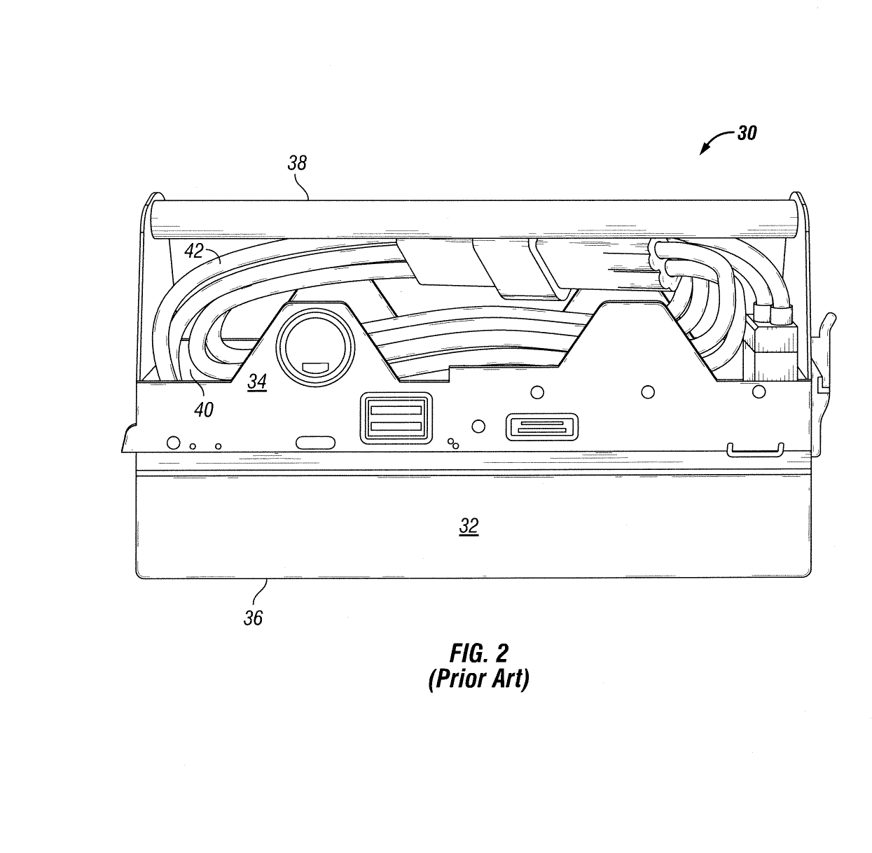

FIG. 3 is a perspective view of a portable ground power unit according to a first embodiment of the invention, showing a light-weight ruggedized plastic battery housing having an integrally formed NATO or other aircraft connector that eliminates the need for heavy, bulky power cables;

FIG. 4 is a plan view of the top of the portable ground power unit of FIG. 3 shown with the upper housing cover removed to reveal its internal battery arrangement and battery control circuitry;

FIG. 5 is a plan view of the bottom of the portable ground power unit of FIG. 3 shown with the bottom housing cover removed to reveal its internal battery arrangement and battery control circuitry; and

FIG. 6 is a perspective view of a ganging cart for use in conjunction with one or more portable ground power units of FIG. 3, showing a plurality of docking stations each with a ground power receptacle into which portable ground power units are plugged providing higher current capacity for starting larger aircraft engines.

### DESCRIPTION OF THE PREFERRED EMBODIMENT OF THE INVENTION

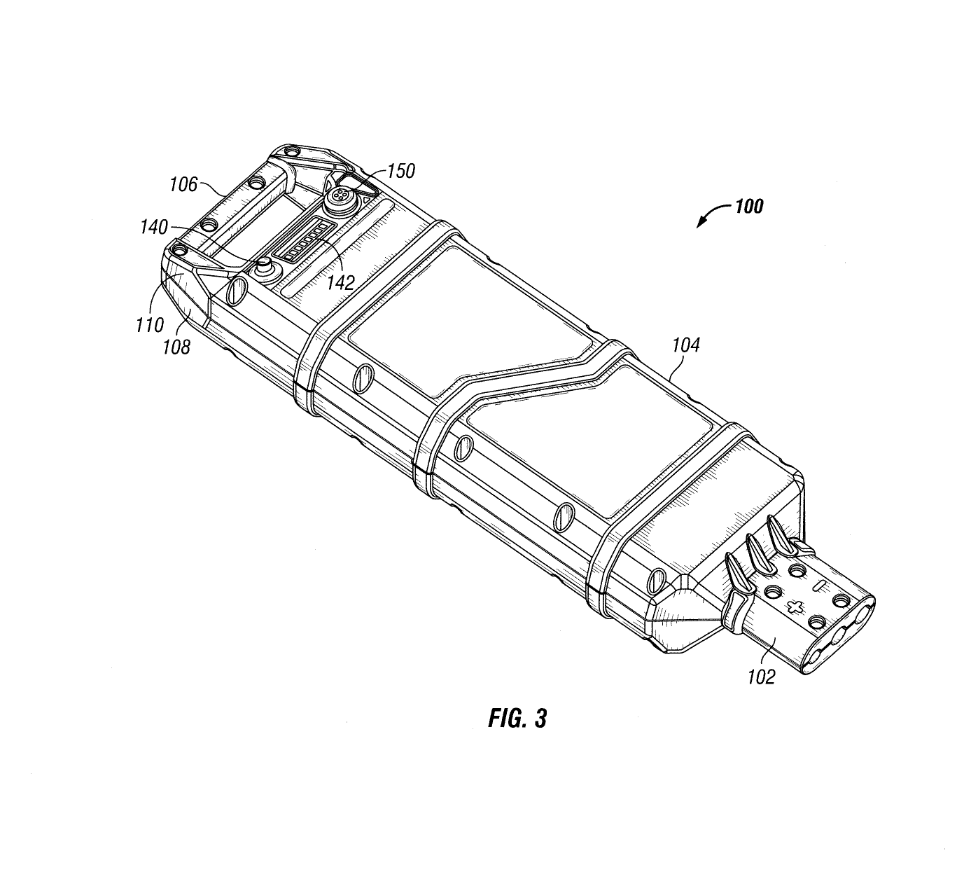

FIG. 3 illustrates a portable ground power unit 100 that eliminates the need for heavy and bulky power cables by incorporating a ground power connector 102, typically a universal 3-pin NATO AN2551 or similar aircraft power connector, into the unit housing 104 to produce a single compact cableless, lightweight, portable, and ergonomic unit. Although ground power unit 100 is illustrated and described with an AN2551 plug for use with the prolific AN2552-3A aircraft ground power receptacle, other suitable connector systems may be used, including two-pin and six-pin connectors, MS25488, MS3349-2, MS25182-2, and MS3509 MIL-SPEC connectors, and the like.

Ground power unit 100 is capable of providing auxiliary and starting power to rotary- and fixed-wing aircraft both during routine maintenance at an airfield or emergency situations in remote locations, for example. Ground power unit 100 is designed and arranged to be carried and charged on board aircraft without significant weight penalty and to plug directly into the aircraft ground power input connector without the use of heavy copper power cables. To start an aircraft engine using ground power unit 100, the unit is simply plugged directly into the aircraft ground power input receptacle and the aircraft is started according to the appropriate startup procedures.

A significant advantage of the portable ground power unit 100 over prior art GPUs is its light weight, compactness, portability, and high power output. By eliminating the use of cables and by integrating the ground power connector 102 into the housing 104, the portable ground power unit 100 of the present invention provides unmatched portability. The portable ground power unit 100 can be simply stowed away in the aircraft to provide emergency backup power if needed. In one embodiment, ground power unit 100 weighs less than thirteen pounds.

Ground power unit 100 is preferably packaged in such a way to make it light weight, easy to transport, easy to store, and easy to charge on-board the aircraft. Accordingly, a carry handle 106 is provided integral with housing 104. Housing 104 is a ruggedized lightweight plastic injection molded formed primarily of a lower housing cover 108 and an upper housing cover 110. Because ground power unit 100 is used primarily in and around the hangar, baggage compartment, and the interior of aircraft; housing 104 should be made from a material that will withstand the chemicals and solvents commonly found in these environments including Jet Fuel, AvGas, Lubricating Oils, and aviation cleaners. For example, housing 104 may be made from Rynite-530 (20% fiber) or equivalent. Ideally, housing 104 is colored high-visibility red or orange similar to that of an Emergency Locator Transmitter (ELT) or a “Remove Before Flight” item so that it is not accidentally used during takeoff or in-flight operation. In addition to any markings required by the Federal Aviation Administration (FAA), additional markings indicating “High Voltage” and “Remove Before Flight” (not illustrated) should be affixed to the exterior of housing 104.

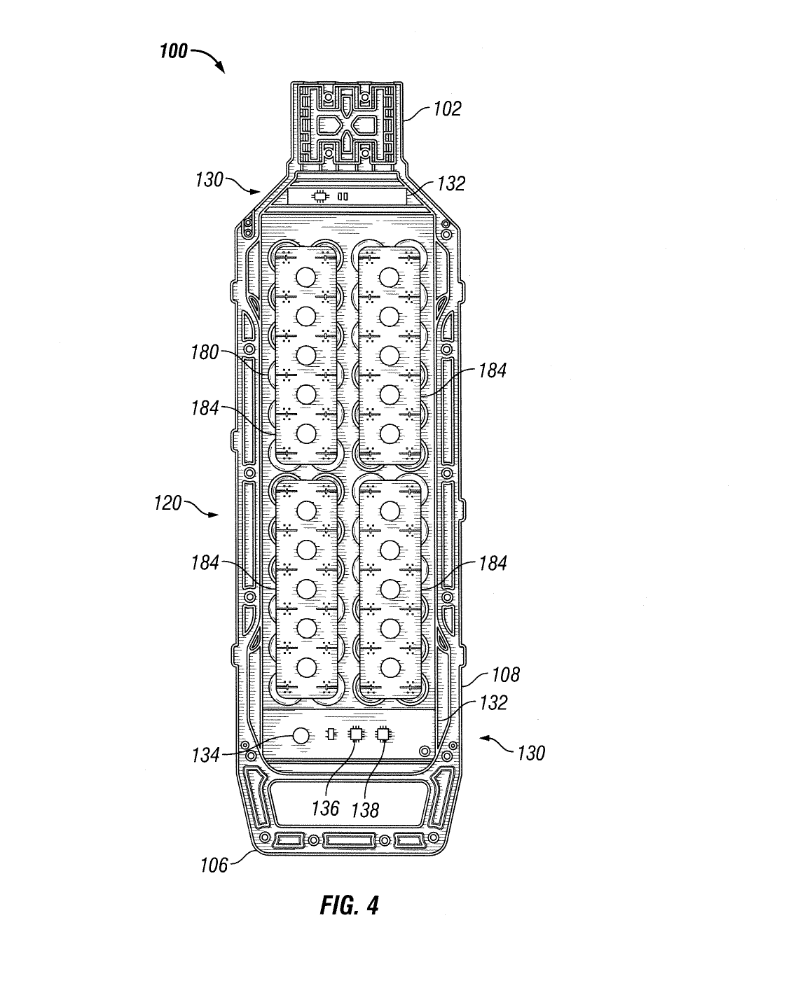

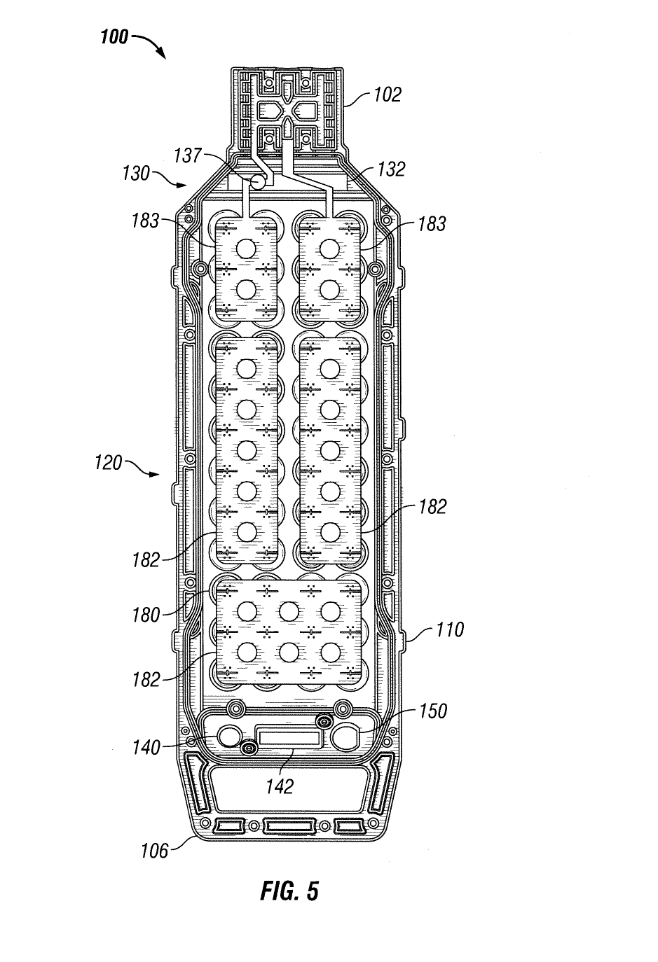

FIGS. 4 and 5 illustrate ground power unit 100 with the upper and lower housing covers 110, 108, respectively, removed to reveal the interior of the unit. A battery assembly 120 is operatively connected to ground power connector 102 via power and control circuitry 130 and buses, which may be carried on one or more printed circuit boards 132, for example. For most aircraft, battery assembly 120 is a nominal 26.4V stand-alone power source, which preferably employs lithium ion technology for reduced weight.

In a preferred embodiment, ground power connector 102 is dimensioned so as to plug into a standard three-pin Mil-Spec ground power connector common to most aircraft. In the standard configuration, the ground power connector has the following pinout:

| | | | |
|---|---|---|---|
| Pin 1 | Negative | 0 VDC | High current |
| Pin 2 | Positive | +24 VDC | High current |
| Pin 3 | Interlock | +24 VDC | Low current |

The ground power connector 102 is designed in such a way that the longer high current pins 1 and 2 must be fully engaged before the shorter pin 3 makes electrical contact. Pin 3 powers a ground power relay interlock aboard the aircraft that ensures adequate engagement of the plug into the receptacle before large currents are allowed to pass so as to prevent arcing. Ground power unit 100 is designed to provide the required +24VDC to pin 3 for ordinary use.

Referring to FIGS. 3-5, ground power unit 100 includes an on-off power button 140, a display screen 142, and a charge connector 150, as described in greater detail below. Display screen 142 is used to show various state of health or state of function conditions, including state of charge, voltage, current, and faults during various modes of operation, as described in further detail below. Display screen 142 is shown as an eight-character night-vision-goggle-compatible alphanumeric display, although other display types may be used as appropriate. For example, various light emitting diode status indicator lights may be used.

Although the battery assembly within ground power unit 100 can be charged via ground power connector 102 (as described below), charge connector 150 provides for convenient charging via a disconnectable power pack (not illustrated) that plugs into readily-available standard AC electric sockets. Charge connector 150 ideally is dust protected, immersion-proof, and protected against contact (for example, Ingress Protection rating of IP67 or better).

Ground power unit 100 is designed so that it can be charged via charge connector while it simultaneously supplies power to an aircraft via the ground power connector 102. This simultaneous charge-and-use feature is particular ideal for various ramp functions, maintenance, or extended avionics use. In a preferred embodiment, ground power unit 100 should be able to handle loads up to 20 amps DC indefinitely when simultaneously charged via charge connector 150. The power and control circuitry 130 of ground power unit 100 includes charging regulation circuitry, with a high-power charging MOSFET 134 or a similar switching circuit element that regulates charging current up to 20 amps using a current-sensing pulse width modulation technique.

A user may also choose to install ground power unit 100 into an aircraft on a semi-permanent basis by wiring the unit into either an auxiliary or dedicated aircraft circuit. Ground power unit 100 ideally includes the ability to limit current draw during charge via charge connector 150 to either 10 or 20 amps, depending on available current capacity of circuit used, so as to not activate the circuit protection on the aircraft. In one embodiment, regulation is selectable by software control of the switching frequency of charging MOSFET 134.

By default, charging current via charge connector 150 is limited to 10 amps by the charging regulation circuitry. However, charge connector 150 includes a pair of contacts (pins 3 and 4) that are used to provide a controller area network (CAN) message signal to the charging regulation circuitry for enabling 20 amp regulation. Accordingly, charge connector 150 has the following pinout:

| | | | | |
|---|---|---|---|---|
| Pin 1 | Charge Positive | +24 VDC | 20 | Amps |
| Pin 2 | Charge Negative | 0 VDC | 20 | Amps |
| Pin 3 | CAN High | +24 VDC | <1 | Amp |
| Pin 4 | CAN Low | 0 VDC | <1 | Amp |

In some aircraft, such as the Eurocopter AS350, auxiliary power supply connectors are not keyed to prevent reverse polarity connection. For this reason, power and control circuitry 130 ideally includes reverse polarity protection in its charging circuitry.

Power and control circuitry 130 also includes a battery management unit 136, which controls and monitors battery assembly 120, providing various battery state and diagnostic information. Battery management unit 136 may be implemented by a microprocessor, a microcontroller, a field programmable gate array (FPGA), or an application specific integrated circuit (ASIC), for example, as is well known in the art. Battery management unit 136 is powered by an internal low voltage (e.g., 2-5 VDC) power supply which is powered from battery assembly 120, charging connector 150, or ground power connector 102 via a DC-DC converter 138, for example.

The primary function of battery management unit 136 is to monitor and control battery output, monitor and control charging, provide diagnostic services, and display information to the user, including the state of health (SOH), state of charge (SOC) and state of function (SOF) of battery assembly 120. Battery management unit 136 controls power MOSFET 137 or similar switching circuit element that is used to turn battery assembly 120 on and off, as well as various analog and/or digital circuits for current and temperature measurements, for example.

Battery management unit 136 preferably includes the ability to be turned on both by the user using switch 140 or automatically if a charger is connected to charge port 150. Ideally, battery management unit 136 is also enabled to inhibit a power-down of the internal low voltage supply if housekeeping is necessary or if charging is being performed, as follows:

| Power Mode | Charge Input | Low Volt Supply | Output |
|---|---|---|---|
| On | Ready | On | On |
| Off | Ready | Off | Off |
| Off | Charging | On | Off |

Battery management unit 136 optimally provides the following functionality:

Display Driver

Battery management unit 136 is coupled to display screen 142. A message scheduler, which is sensitive to the various operating modes of battery assembly 120, determines when and what messages are to be displayed on display screen 142. In a preferred embodiment, battery management unit 136 classifies the modes of battery operation and displays corresponding outputs on display screen 142 as follows:

| State | SubState | Display | Output |
|---|---|---|---|
| Off | N/A | None (blank) | De-energized |
| On | Ready | State of Charge | Energized |
| On | Discharging | Current | Energized |
| On | Critical Fault | Fault code | De-Energized |
| On | Warning Fault | Fault code | Energized |
| On | Charging | State of Charge, Current | Energized |
| Off | Charging | State of Charge, Current | De-energized |

State of Charge

Much academic and government-sponsored research has been done on SOC estimation using a variety of models that take into account battery chemistry, voltage, and/or current integration. The battery management unit preferably estimates SOC using current integration techniques. A Kalman filter or similar algorithm may be used to improve the accuracy of the SOC estimation in real time.

State of Health, Overcurrent Protection, and Diagnostics

Operational parameters for battery assembly 120, including maximum steady-state and transient current draws, are used by battery management unit 136 to ensure that the battery assembly parameters are not violated. This information is also used to determine the remaining useful life of the battery and to generate diagnostics, for example, as shown in the table below.

| Code | Fault | Output |
|---|---|---|
| 101 | Cell out of Balance (warning) | Energized |
| 102 | Cell out of Balance (fault) | De-energized |
| 103 | Exceed Steady State Limit | De-energized |
| 104 | Exceed 10 Second Limit | De-Energized |
| 105 | Low Pack Voltage | De-Energized |
| 106 | Cell End-of-Life | Energized |
| 107 | Pack Cold | Energized |
| 108 | FET Failure | Energized |

Battery management unit 136 has the ability to de-energize the output by turning off power MOSFET 137 if steady-state or transient discharge rate limits are reached. Circuit protection is similar to that of a thermal fuse; circuit protection activation is delayed and dependent on both the amount of overcurrent and length of time. After overcurrent protection is activated, resetting is prohibited until a particular time as elapsed, which is also preferably a function of time at overcurrent.

Hot Start Prevention

A “hot start” is a condition in which a gas turbine engine exceeds allowable temperatures during the starting process. The condition may be caused by insufficient mass air flow through the combustion chamber or turbine (exhaust) section during light-off, which results in a temperature spike at ignition that exceeds material limits. A hot start can result in many thousands of dollars' worth of engine damage. Accordingly, it is imperative that the required motoring speed of a turbine engine be maintained at required levels during the starting process.

Using SOC and SOH information along with appropriate battery parameters and limitations, ground power unit 100 advises the user whether or not it is safe to perforin an engine start. In one embodiment, battery management unit 136 will automatically disconnect battery assembly 120 from ground power connector 102 by turning off MOSFET 137 when parameters indicate an undercharged or underperforming battery assembly 120, thereby solving the problem of users accidentally attempting a start when battery conditions could result in a hot start.

Temperature Monitoring

Ground power unit 100 is ideally operational in temperatures ranging from −30° C. to 55° C. with no de-rating. For temperatures at the lower end of this range, it may be necessary, however, to cycle ground power unit 100 by applying a load before an engine start can be safely performed. In this case, ground power unit 100 is designed and arranged to notify the user when cycling is required.

FIGS. 4 and 5 illustrate the configuration of battery assembly 120 according to a first embodiment of the invention. Forty-eight individual cylindrical battery cells 180 are arranged in eight groups of six (2×3 cells), with the battery polarities of the groups selectively alternated. Five bottom metallic plates 182, 183 and four top metallic plates 184 are each electrically connected to the electrodes of one or two groups of six battery cells 180, such as by spot welding.

Specifically, each plate 182, 184, electrically connects the positive electrodes of one group of six battery cells 180 and the negative electrodes of another group of six battery cells 180. Plates 183 each connect like terminals of only one group of six battery cells (one plate positive, the other plate negative) to the appropriate bus for supplying ground power connector 102. Accordingly, the design and arrangement of battery cells 180 and plates 182, 183, 184 is such that it results in a series connection of eight groups of six cells 180 connected in parallel (i.e., a 6P8S configuration).

In a preferred embodiment, battery cells 180 are high power lithium ion cells. More preferably still, battery cells 180 are A123 Lithium NanoPhosphate ANR26650M1-B cells. Such cells are commercially available from A123 Systems, Inc. Each such cell has a nominal voltage of 3.3V, a nominal capacity of 2.5Ah, and is capable of discharge of 50 amps continuously and 120 amps for a transient 10 second-period.

In an alternative embodiment (not illustrated), battery assembly 120 includes thirty-two, rather than forty-eight, A123 Lithium NanoPhosphate ANR26650M1-B cells in a series connection of eight groups of four cells connected in parallel (i.e., a 4P8S configuration). In such an arrangement, each battery assembly has a nominal voltage of 26.4 volts, a continuous output of 200 amps, and a ten-second transient output of 480 amps. This latter embodiment has the advantage of a smaller footprint and lighter weight for aircraft with smaller engines.

Indeed, ground power unit 100 can be designed and constructed with a varying number of battery configurations of various capacities, therefore allowing a user to choose the lightest ground power unit that satisfies his or her power requirements. As such, ground power unit 100 can be designed to start any rotorcraft engine, including the Turbomeca Arriel 2D turbine engine, which is installed in the Eurocopter AS350 B3e and represents a worst-case starting battery load for most of the civilian rotorcraft market.

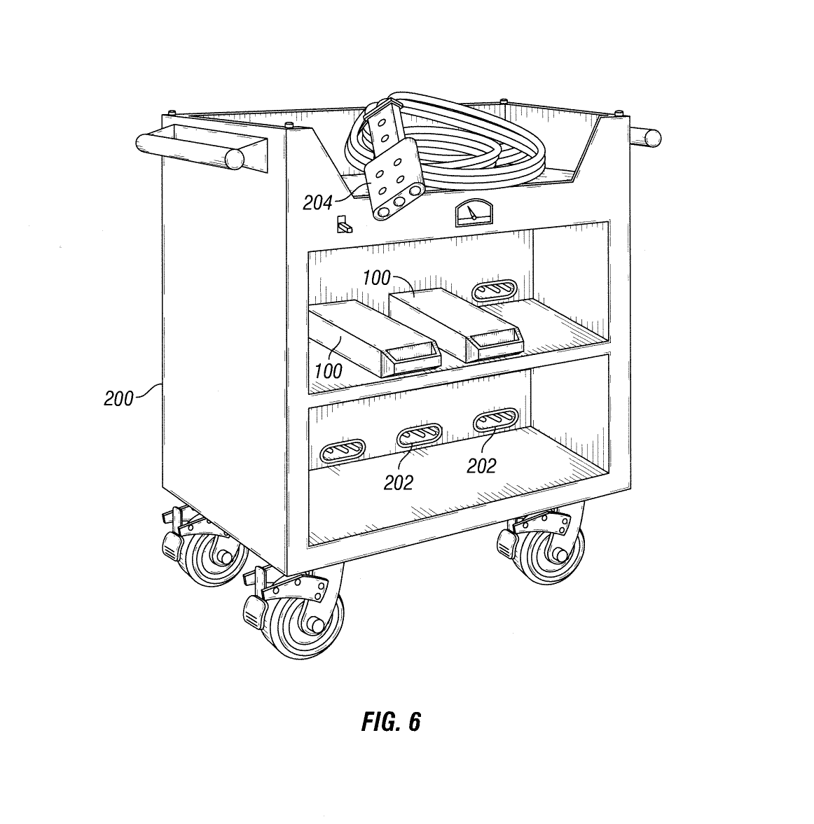

Referring now to FIG. 6, ground power unit 100 is designed and arranged so that it can be docked into a ganging cart 200 for the outputs of numerous ground power units 100 together in a parallel fashion, thereby providing starting capacity for much larger aircraft. Charger cart 200 preferably includes several docking stations, each having a ground power connector 202 of the same profile and configuration as an aircraft ground power input connector. A ground power unit 100 can be docked at each station by mating its ground power plug 102 with the docking station's ground power connector 202. A power cable terminated with a ground power connector 204 is connected to the aircraft ground power input receptacle.

The Abstract of the disclosure is written solely for providing the United States Patent and Trademark Office and the public at large with a way by which to determine quickly from a cursory reading the nature and gist of the technical disclosure, and it represents solely a preferred embodiment and is not indicative of the nature of the invention as a whole.

While some embodiments of the invention have been illustrated in detail, the invention is not limited to the embodiments shown; modifications and adaptations of the above embodiment may occur to those skilled in the art. Such modifications and adaptations are in the spirit and scope of the invention as set forth herein:

What is claimed is:

1. A ground power apparatus for powering an aircraft, comprising:
a housing;
a battery disposed in said housing; and
a ground power connector dimensioned so as to mate with a ground power input connector of said aircraft, said ground power connector being integrally formed as a first part of said housing and being operatively connected to said battery without using external electrical cabling; whereby
said apparatus can be plugged into said ground power input connector of said aircraft to power said aircraft without using external electrical cabling.

2. The ground power apparatus of claim 1, wherein:
said ground power connector is characterized by a geometry that is substantially the same as a NATO AN2551 plug so as to mate with said ground power input connector of said aircraft having a NATO AN2552-3A socket.

3. The ground power apparatus of claim 1, further comprising:
a carry handle integrally formed as a second part of said housing.

4. The ground power apparatus of claim 1, further comprising:
a charging connector mounted to said housing and operatively coupled to said battery via a charging circuit, said charging circuit being designed and arranged to allow regulated charging of said battery via said charging connector at selectably controllable first and second current limits.

5. The ground power apparatus of claim 1, further comprising:
a display mounted to said housing; and
a battery management unit operatively coupled to said battery, said battery management unit being designed and arranged to monitor at least one from the group consisting of current, voltage, battery charge, temperature, and polarity, said battery management unit being further designed and arranged to indicate on said display at least one from the group consisting of a state of charge, a state of function, and a state of health of said battery.

6. The ground power apparatus of claim 1, further comprising:
a ganging station having a plurality of docks each dimensioned for receiving a ground power apparatus, each dock including power connector dimensioned so as to mate with said ground power connector of said ground power apparatus, said ganging station being designed and arranged for electrically combining the output of a plurality of said ground power apparatus in a parallel.

7. The ground power apparatus of claim 1, wherein:
said battery includes a plurality of individual lithium ion battery cells.

8. A method for providing ground power to an aircraft, comprising the steps of:
providing a portable ground power unit having an enclosure that houses a battery and that includes an integrated ground power connector operatively connected to said battery; and
plugging said ground power unit into a ground power input connector of said aircraft to thereby provide electrical power from said battery to said aircraft without the need for electrical cables.

9. The method of claim 8, wherein:
said ground power unit further includes a charging connector operatively coupled to said battery via a charging circuit, said charging circuit being designed and arranged to allow regulated charging of said battery via said charging connector at selectably controllable first and second charging current limits; and
the method further comprises the steps of,
connecting said charging connector within an electrical circuit of said aircraft,
selecting either said first or said second charging current limit so that a current capacity of said electrical circuit of said aircraft is not exceeded, and
charging said battery using said electrical circuit of said aircraft via said charging connector and said charging circuit.

10. The method of claim 8, wherein:
said ground power unit further includes a charging connector operatively coupled to said battery via a charging circuit, said charging circuit being designed and arranged to allow regulated charging of said battery via said charging connector; and
the method further comprises the steps of,
connecting said ground power connector of said ground power unit to said ground power input connector of said aircraft,
connecting said charging connector to a source of electrical power that is independent of said ground power unit and said aircraft; and
powering said aircraft via said ground power connector while simultaneously charging said battery using said independent source of electrical power.

11. The method of claim 8, further comprising the steps of:
monitoring by said ground power unit at least one from the group consisting of current, voltage, battery charge, temperature, and polarity; and
determining by said ground power unit at least one from the group consisting of a state of charge, a state of function, and a state of health of said battery.

12. The method of claim 11, further comprising the step of:
automatically disconnecting by said ground power unit said battery from said ground power connector when said at least one from the group consisting of a state of charge, a state of function, and a state of health of said battery indicates a weakened state of said ground power unit; whereby
said ground power unit minimizes the possibility of a hot start of an engine of said aircraft.

13. The method of claim 11, further comprising the step of:
displaying by said ground power unit said at least one from the group consisting of a state of charge, a state of function, and a state of health of said battery.

14. The method of claim 8, further comprising the steps of:
providing a ganging station having first and second connectors each dimensioned to mate with said ground power connector of said ground power unit;
plugging said ground power unit into said first connector;
plugging a second ground power unit into said second connector; and
electrically connecting an output of said ground power unit in parallel with an output of said second ground power unit and said ground power input connector of said aircraft.
